(19) United States
(12) Patent Application Publication
(10) Pub. No.: US 2013/0106314 A1
(43) Pub. Date: May 2, 2013

(54) XENON LAMP ILLUMINATION APPARATUS

(71) Applicant: POONG GI JEONG, JEONJU (KR)

(72) Inventor: POONG GI JEONG, JEONJU (KR)

(21) Appl. No.: 13/286,315

(22) Filed: Nov. 1, 2011

(51) Int. Cl. H05B 41/04

(52) U.S. Cl. 315/313

(57) ABSTRACT

Provided is a xenon lamp illumination apparatus, and more particularly, a xenon lamp illumination apparatus including a plurality of arc tubes in an outer tube such that the arc tubes can be sequentially ignited to remarkably improve a lifespan thereof.

### BACKGROUND

1. Field of the Invention

The present invention relates to a xenon lamp illumination apparatus.

2. Description of the Related Art

An illumination apparatus uses various light sources according to required luminous intensity, installation places, cost, and so on.

In recent times, while a halogen lamp or a mercury lamp having high luminous intensity are used as the light sources, research on an illumination apparatus capable of reducing power consumption, lengthening durability and a lifespan, and providing high luminous intensity has been continuously performed.

In particular, since a high luminous intensity illumination apparatus requires a correspondingly high voltage, a stabilizer for supplying a voltage is needed so that efficiency is decreased, a lifespan of the lamp and the stabilizer is limited thereby increasing costs, and maintenance and management thereof require a large amount of efforts and costs.

Since the xenon lamp illumination apparatus, which is a lighting system using emission by discharge generated in a xenon gas, can emit light closest to natural light in comparison with other illumination apparatus and easily adjust the luminous intensity, the apparatus is widely used in various fields.

However, since the conventional xenon lamp illumination apparatus must have a stabilizer of its own, and the xenon lamp must be replaced with a new one when the lifespan of the arc tube in the xenon lamp ends like another lamp, the conventional xenon lamp illumination apparatus also has problems similar to a conventional another illumination apparatus.

### SUMMARY

Accordingly, it is an aspect of the present invention to provide a xenon lamp illumination apparatus including a plurality of arc tubes in an outer tube such that the arc tubes can be sequentially ignited to remarkably improve a lifespan thereof.

It is an aspect of the present invention to provide a xenon lamp illumination apparatus having a simple structure of fastening a connecting terminal of a base part to a ground fixing groove of a ground part to be electrically connected to the plurality of arc tubes, improving productivity and more easily performing an initial installation and an exchange thereof.

It is an aspect of the present invention to provide a xenon lamp illumination apparatus capable of stably igniting the plurality of arc tubes using a stabilizer including the plurality of igniting parts configured to supply a starting voltage to the plurality of arc tubes disposed therein and a switching part configured to adjust voltage supply signals of the igniting parts, and sequentially igniting the plurality of arc tubes to remarkably lengthen a lamp exchange period.

According to an aspect of the present invention, a xenon lamp illumination apparatus includes: a xenon lamp which includes an outer tube having an opening at one side of the outer tube, a plurality of arc tubes filled with a xenon gas and installed in the outer tube, the plurality of arc tubes disposed at predetermined intervals in a longitudinal direction of the outer tube, inner tubes extending from both sides of the arc tubes in the longitudinal direction of the outer tube, a first discharge metal and a second discharge metal installed in each of the inner tubes, a support part extending inside the outer tube in the longitudinal direction and electrically connected to the first discharge metal, and a base part configured to close the opening of the outer tube and having a plurality of connecting terminals electrically connected to the second discharge metal and the support part; a ground part having a plurality of ground fixing grooves into which the connecting terminals of the base part are fixedly inserted and grounded; and a stabilizer connected to the ground fixing grooves of the ground part, the stabilizer including a plurality of igniting parts configured to supply a starting voltage to the arc tubes, respectively, and a switching part configured to adjust electrical signals such that the plurality of igniting parts are sequentially operated to apply a power to one of the other arc tubes when a lifespan of the one arc tube ends.

According to an aspect of the present invention, at least one of the arc tubes and the inner tubes of the xenon lamp may be formed of a ceramic material.

According to an aspect of the present invention, the arc tubes of the xenon lamp may have an oval cross-section.

According to an aspect of the present invention, the plurality of connecting terminals may include a support part connecting terminals formed at a center region of the base part to be electrically connected to the support part, and a plurality of second discharge metal connecting terminals are formed at an outer circumference of the base part to be electrically connected to the second discharge metal,

According to an aspect of the present invention, the plurality of second discharge metal connecting terminals may have different sizes, and the ground fixing grooves grounded to the second discharge metal connecting terminals may have shapes corresponding to the second discharge metal connecting terminals having different sizes.

According to an aspect of the present invention, the xenon lamp illumination apparatus may further include springs arranged at one or both of the support part connecting terminal of the xenon lamp and the ground fixing groove of the ground part.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 to 3 are a perspective view, an exploded perspective view and a cross-sectional view of a xenon lamp illumination apparatus in accordance with an embodiment of the present invention, respectively;

FIGS. 4A and 4B are a plan view of a base part and a ground part of the xenon lamp illumination apparatus, respectively, in accordance with an embodiment of the present invention;

FIGS. 5A and 5B are a schematic view showing an operation of the xenon lamp illumination apparatus in accordance with an embodiment of the present invention; and

FIG. 6 is a view showing another example of the xenon lamp illumination apparatus in accordance with the present invention.

### DETAILED DESCRIPTION

A xenon lamp illumination apparatus 1000 of an embodiment of the present invention will be described in detail with reference to the accompanying drawings.

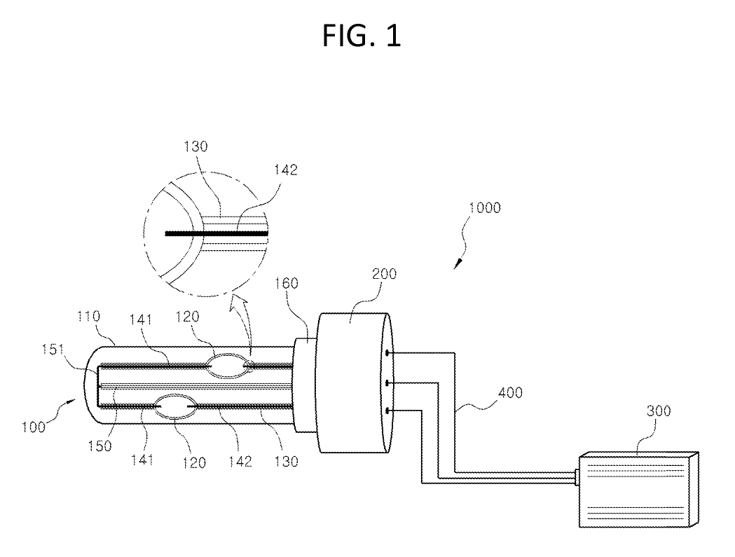

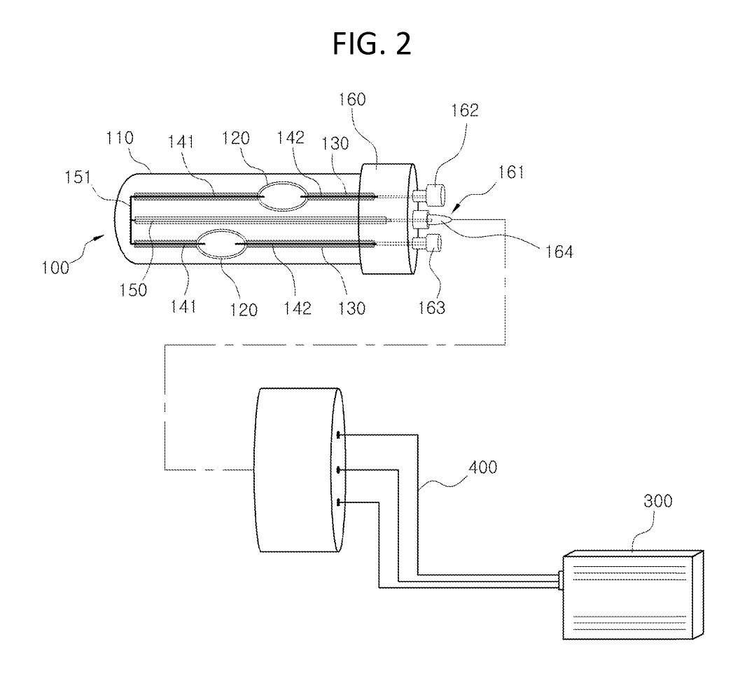

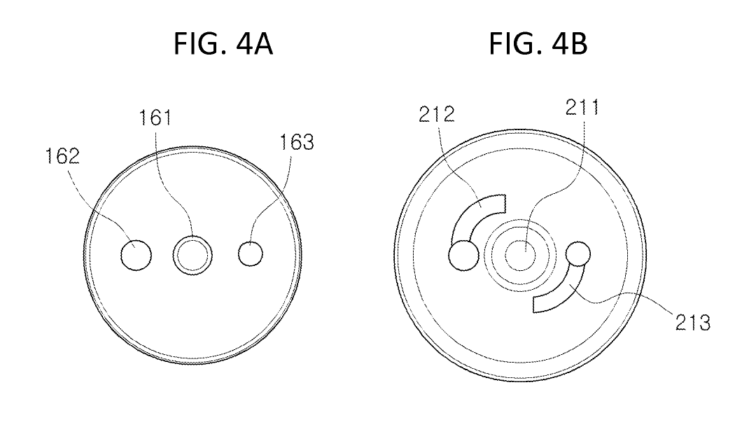

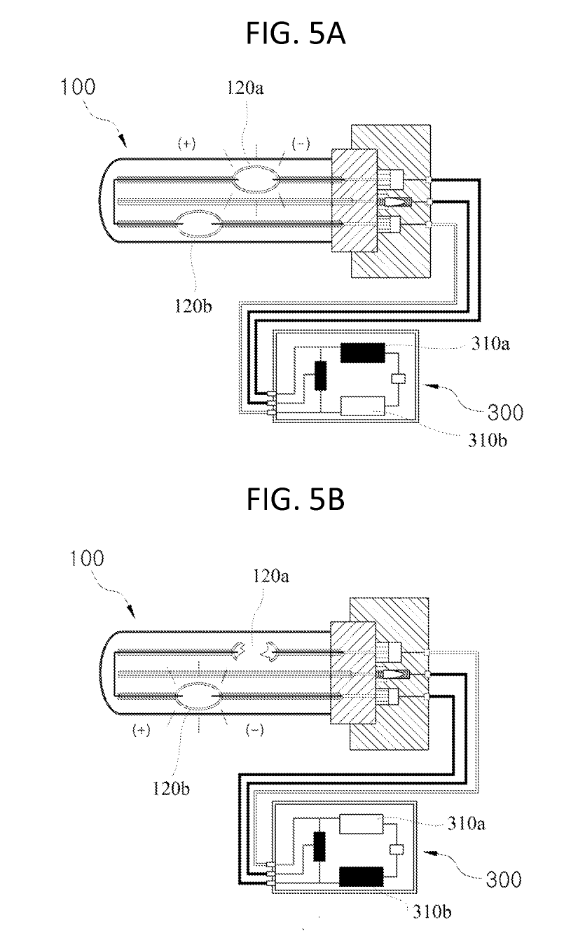

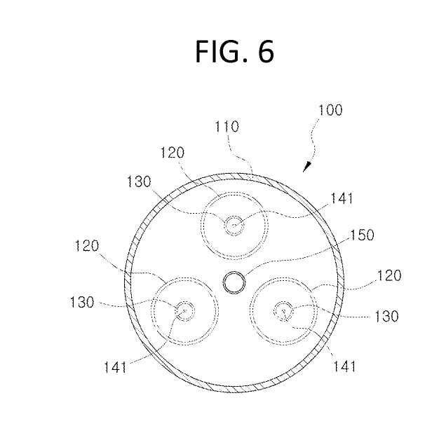

FIGS. 1 to 3 are a perspective view, an exploded perspective view and a cross-sectional view of the xenon lamp illumination apparatus 1000 in accordance with the present invention, FIGS. 4A and 4B are a plan view of a base part 160 and a ground part 200 of the xenon lamp illumination apparatus 1000, respectively, in accordance with an embodiment of the present invention, FIG. 5 is a schematic view showing an operation of the xenon lamp illumination apparatus 1000 in accordance with an embodiment of the present invention, and FIG. 6 is a view showing another example of the xenon lamp illumination apparatus 1000 in accordance with the present invention.

The xenon lamp illumination apparatus 1000 of an embodiment of the present invention includes the xenon lamp 100, the ground part 200 and a stabilizer 300.

The xenon lamp 100, which is an emission part, is replaceably fixed to the ground part 200 to receive a starting voltage.

First, the xenon lamp 100 includes an outer tube 110, an arc tube 120, inner tubes 130, a first discharge metal 141, a second discharge metal 142, a support part 150, and a base part 160.

The outer tube 110 is configured to protect an inner configuration from the outside of the xenon lamp 100, and generally formed of a glass material.

The outer tube 110 has a shape in which a certain space is formed therein, with one side opened and extending in a longitudinal direction thereof.

The base part 160 is configured to close the opened one side of the outer tube 110, and includes a support part 150 installed therein, and a plurality of connecting terminals 161, 162 and 163 configured to apply a voltage to the second discharge metal 142 of the inner tube 130.

Here, a connecting terminal 161 electrically connected to the support part 150 is referred to as a support part connecting terminal 161, and connecting terminals 162 and 163 electrically connected to the second discharge metal 142 are referred to as second discharge metal connecting terminals 162 and 163.

The arc tube 120 is installed in the outer tube 110 and filled with a xenon gas to emit light. The xenon lamp illumination apparatus 1000 of an embodiment of the present invention includes two or more arc tubes 120 installed in the outer tube 110.

FIGS. 1 to 5 show an example in which two arc tubes 120 are formed, and FIG. 6 shows an example in which three arc tubes 120 are formed.

FIG. 6 shows a cross-sectional view of the xenon lamp 100.

Since the arc tube 120 is damaged due to an inner pressure to thereby terminate the lifespan when the xenon gas is exhausted, the xenon lamp illumination apparatus 1000 of the present invention includes two or more arc tubes 120 installed in a single outer tube 110 and the arc tubes 120 are sequentially emitted to remarkably lengthen the lifespan thereof.

Here, since the arc tubes 120 emit light and simultaneously discharge heat to the outside, the plurality of arc tubes 120 are spaced apart from each other in a longitudinal direction of the outer tube 110 to minimize an influence caused by emission from another arc tube 120 on one arc tube 120.

In FIGS. 1, 2, 3 and 5, the longitudinal direction of the outer tube 110 means a left and right direction.

According to an embodiment of the present invention, the arc tubes 120 may have an oval cross-section with smooth curves.

When the arc tubes 120 have a cross-sectional shape with corners, the light may be scattered or concentrated to one point. The arc tubes 120 of the xenon lamp illumination apparatus 1000 of an embodiment of the present invention have an oval cross-section to evenly emit light to increase optical efficiency thereof, thereby reducing damage due to the heat.

The inner tubes 130 extend from both sides of the arc tube 120 in the longitudinal direction of the outer tube 110, each including the first discharge metal 141 and the second discharge metal 142 formed at both sides thereof.

The inner tubes 130 may be integrally formed with the arc tubes 120, and both of the inner tubes 130 and the arc tubes 120 may be formed of a ceramic material.

The first discharge metal 141 and the second discharge metal 142 are installed at the inner tubes 130 extending from both sides of the arc tubes 120, and have positive (+) and negative (−) polarities to discharge the xenon gas in the arc tubes 120.

Here, the first discharge metal 141 and the second discharge metal 142 may be formed of a metal material having electrical conductivity, typically, tungsten.

All of the connecting terminals 161, 162 and 163 configured to apply the voltage to the first discharge metal 141 and the second discharge metal 142 are formed at the base part 160, and thus, the support part 150 is configured to be electrically connected to the first discharge metal 141.

The support part 150 extends in the longitudinal direction of the outer tube 110, and has a connecting wire 151 formed at its end to be connected to the first discharge metal 141.

The support part 150 is configured to extend in the outer tube 110 in the longitudinal direction such that the voltage supplied by the ground between the ground fixing groove 211 of the ground part 200 and the support part connecting terminal 161 of the base part 160 is applied to the first discharge metal 141. An end of the support part 150 is electrically connected to the first discharge metal 141 installed in the inner tube 130 connected to the plurality of arc tubes 120.

The inner tube 130 in which the second discharge metal 142 is installed is positioned to abut in the base part 160, and the second discharge metal connecting terminals 162 and 163 corresponding to the number of the arc tubes 120 are installed at the base part 160.

Here, the base part 160 has the support part connecting terminal 161 formed at a center region thereof, and the plurality of second discharge metal connecting terminals 162 and 163 are formed at an outer circumference thereof.

Since the second discharge metal connecting terminals 162 and 163 (including all components of the inner tubes 130 and the arc tubes 120 connected to the second discharge metal connecting terminals 162 and 163) may be formed at positions farthest from each other to minimize an influence therebetween, as shown in FIGS. 4A and 6, when the two arc tubes 120 are formed, the second discharge metal connecting terminals 162 and 163 are formed at positions of about 180° with respect to the support part connecting terminal 161, and when the three arc tubes 120 are formed, the second discharge metal connecting terminals 162 and 163 are formed at positions of about 120° with respect to the support part connecting terminal 161.

Since the connecting terminals 161, 162 and 163 of the base part 160 are fixedly inserted to be grounded to the ground fixing grooves 211, 212 and 213 of the ground part 200, the grooves 211, 212 and 213 have a shape corresponding to the shape of the connecting terminals 161, 162 and 163.

When the plurality of arc tubes 120 are formed, since it is impossible to discriminate which arc tube 120 belongs to which connecting terminal 162 or 163 when the second discharge metal connecting terminals 162 and 163 of the base part 160 have the same shape, the plurality of second discharge metal connecting terminals 162 and 163 may have different sizes, and the ground fixing grooves 212 and 213 grounded to the second discharge metal connecting terminals 162 and 163 may be formed to correspond to the second discharge metal connecting terminals 162 and 163 having different sizes.

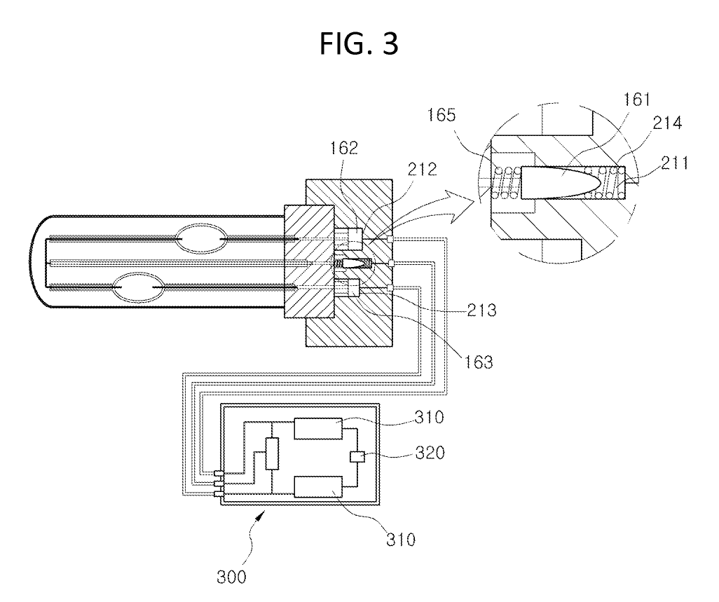

A resilient part 164 having a resilient force by a spring 165 may be arranged at an end of the support part connecting terminal 161, and the ground fixing groove 211 to which the support part connecting terminal 161 is grounded may be formed to have a spring 214 inserted thereinto, offsetting vibrations caused by an external force (see the cross-sectional view of FIG. 3).

FIG. 3 shows an example in which the spring 165 is arranged at the support part connecting terminal 161, and the spring 214 is inserted into the ground fixing groove 211. In the xenon lamp illumination apparatus 1000 of an embodiment of the present invention, the springs 165 and 214 may be arranged at only one of the support part connecting terminal 161 and the ground fixing groove 211.

In FIG. 4B, there is shown an example in which the xenon lamp 100 is rotated with respect to the ground part 200 to be fixed thereto. That is, the second discharge metal connecting terminals 162 and 163 have ends with increased diameters to form stepped portions, the connecting terminals 162 and 163 of the second discharge metal 142 are partially inserted into the ground fixing groove 212 and 213 and rotated such that the attaching and detaching in the longitudinal direction of the outer tube 110 are prohibited by the stepped portions.

The xenon lamp 100 of an embodiment of the present invention may be fixed through a separate fixing method, and the xenon lamp 100 and the ground part 200 may be easily fixed to each other through various methods, in addition to the above example.

The stabilizer 300 is connected to the ground fixing grooves 211, 212 and 213 of the ground part 200 to apply a starting voltage.

Here, the ground part 200 and the stabilizer 300 may be connected to each other by a cable 400. When the ground part 200 and the stabilizer 300 are disposed far from each other, a connector (not shown) configured to connect each component to the cable 400 may be used.

The plurality of igniting parts 310a and 310b configured to supply the starting voltage to the plurality of arc tubes 120a and 120b are formed in the stabilizer 300, and the switching part 320 configured to adjust an electrical signal is installed at the plurality of igniting parts 210 to sequentially operate the igniting parts 210.

That is, the xenon lamp illumination apparatus 1000 of an embodiment of the present invention supplies a power to one of the arc tubes 120 by one of the igniting parts 310 to emit light. When the lifespan of the arc tube 120 ends, another igniting part 310 is operated by the switching part 320, and thus, a power is supplied to another arc tube 120 to emit light.

More specifically, the stabilizer 300 always supplies a positive (+) power to the support part 150. First, as shown in FIG. 5A, when one igniting part 310a disposed at an upper side of the drawing supplies a negative (−) power to the arc tube 120a by control of the switching part 320, the arc tube 120a disposed at the upper side emits light.

When the arc tube 120a disposed at the upper side of the drawing is damaged as time elapses, as shown in FIG. 5B, the other igniting part 310b disposed at a lower side of the drawing supplies a negative (−) power to the arc tube 120b by control of the switching part 320, such that the arc tube 120b disposed at the lower side emits light.

Accordingly, the xenon lamp illumination apparatus 1000 of an embodiment of the present invention can use the plurality of illumination apparatus corresponding to the number of arc tubes 120 using the one xenon lamp 100 to remarkably lengthen the lifespan thereof, increasing an exchange cycle thereof and thus reducing consumption costs of maintenance and exchange operations.

In addition, the xenon lamp illumination apparatus 1000 of an embodiment of the present invention integrates the stabilizer 300, the support part 150 and the outer tube 110 to supply a power to the plurality of arc tubes 120, simplifying a configuration thereof.

In the drawings, the second discharge metal 142 connected to the base part 160 is shown at a right side thereof, and the first discharge metal 141 connected to the support part 150 is shown at a left side thereof.

As can be seen from the foregoing, the xenon lamp illumination apparatus of the present invention can stably ignite the plurality of arc tubes formed in the single outer tube using the stabilizer including the plurality of igniting parts configured to supply a starting voltage to the plurality of arc tubes and the switching part configured to adjust the voltage supply signals of the igniting parts, sequentially ignite the arc tubes to remarkably lengthen the lifespan thereof, and thus, increase the lamp exchange cycle.

In addition, it is possible to provide a xenon lamp illumination apparatus having a simple structure of fastening a connecting terminal of a base part to a ground fixing groove of a ground part to be electrically connected to the plurality of arc tubes, improving productivity and more easily performing an initial installation and an exchange thereof.

Here, the second discharge metal connecting terminals connected to the plurality of arc tubes may have different sizes and the ground fixing grooves are formed to correspond to the connecting terminals to be easily electrically connected thereto, even when the plurality of arc tubes are formed.

In addition, the xenon lamp illumination apparatus of the present invention includes the plurality of arc tubes disposed at predetermined intervals in the longitudinal direction of the outer tube to prevent transfer of heat generated when the one arc tube is turned on to the other arc tube.

Further, in the xenon lamp illumination apparatus of the present invention, since the arc tubes have the oval cross-section, the heat generated in the arc tubes can be more evenly distributed rather than concentrated to one position, and the light can be uniformly emitted to the entire region to increase optical efficiency thereof.

a. While the invention has been shown and described with reference to certain example embodiments thereof, it will be understood by those skilled in the art that various changes in form and details may be made therein without departing from the spirit and scope of the invention as defined by the appended claims.

What is claimed is:

1. A xenon lamp illumination apparatus comprising:
a xenon lamp comprising:
an outer tube having an opening at one side of the outer tube;
a plurality of arc tubes filled with a xenon gas and installed in the outer tube, the plurality of arc tubes disposed at predetermined intervals in a longitudinal direction of the outer tube;
inner tubes extending from both sides of the arc tubes in the longitudinal direction of the outer tube
a first discharge metal and a second discharge metal installed in each of the inner tubes;
a support part extending inside the outer tube in the longitudinal direction and electrically connected to the first discharge metal; and
a base part configured to close the opening of the outer tube and having a plurality of connecting terminals electrically connected to the second discharge metal and the support part;
a ground part having a plurality of ground fixing grooves into which the connecting terminals of the base part are fixedly inserted and grounded; and
a stabilizer connected to the ground fixing grooves of the ground part, the stabilizer comprising a plurality of igniting parts configured to supply a starting voltage to the arc tubes, respectively, and a switching part configured to adjust electrical signals such that the plurality of igniting parts are sequentially operated to apply a power to one of the other arc tubes when a lifespan of the one arc tube ends.

2. The xenon lamp illumination apparatus according to claim 1, wherein at least one of the arc tubes and the inner tubes of the xenon lamp are formed of a ceramic material.

3. The xenon lamp illumination apparatus according to claim 2, wherein the arc tubes of the xenon lamp have an oval cross-section.

4. The xenon lamp illumination apparatus according to claim 1, wherein the plurality of connecting terminals comprises a support part connecting terminals formed at a center region of the base part to be electrically connected to the support part, and a plurality of second discharge metal connecting terminals are formed at an outer circumference of the base part to be electrically connected to the second discharge metal,

5. The xenon lamp illumination apparatus according to claim 4, wherein the plurality of second discharge metal connecting terminals have different sizes, and the ground fixing grooves grounded to the second discharge metal connecting terminals have shapes corresponding to the second discharge metal connecting terminals having different sizes.

6. The xenon lamp illumination apparatus according to claim 4, further comprising springs arranged at one or both of the support part connecting terminal of the xenon lamp and the ground fixing groove of the ground part.
